(19) United States
(12) Patent Application Publication
(10) Pub. No.: US 2008/0295720 A1
(43) Pub. Date: Dec. 4, 2008

(54) Method For Making A Lithographic Printing Plate

(75) Inventors: Emiel Verdonck, Berlaar (BE); Hieronymus Andriessen, Beerse (BE)

Correspondence Address: AGFA;c/o KEATING & BENNETT, LLP, 1800 Alexander Bell Drive, SUITE 200, Reston, VA, 20191, US

(73) Assignee: AGFA GRAPHICS NV, Mortsel (BE)

(21) Appl. No.: 12/158,084

(22) PCT Filed: Dec. 5, 2006
(86) PCT No.: PCT/EP2006/069295

§ 371 Date: Jun. 19, 2008

Related U.S. Application Data
(60) Provisional application No. 60/755,985, filed on Jan. 4, 2006.

(30) Foreign Application Priority Data
Dec. 20, 2005 (EP) 05112506.0

(51) Int. Cl. B41N 3/00

(52) U.S. Cl. 101/463.1

(57) ABSTRACT

A method for making a lithographic printing plate includes the steps of a) providing an aqueous fluid containing at least 2 weight % of a fluorosurfactant based on the total weight of the aqueous fluid wherein the fluorosurfactant has a phosphorous containing group capable of reacting with the surface of a lithographic printing plate precursor; and b) jetting the aqueous fluid on the surface of a lithographic printing plate precursor.

### TECHNICAL FIELD

The present invention relates to lithographic printing plates and methods for their preparation by means of inkjet.

### BACKGROUND ART

Over the last decade, the graphic arts workflow has changed dramatically, evolving from a computer to film work flow to a computer to plate workflow. Direct plate making is becoming the dominating technology. In the market, preferentially using thermal or photo-polymerization technology. The majority of the commercial systems are processing required systems, using an alkaline developer to process the plates after imaging. In recent years, there is a clear tendency towards printing plates requiring no processing, such as for example a developing step to obtain the lithographic image.

Also over the last decade, the image quality of inkjet systems has evolved to a level where it becomes an option for direct imaging of printing plate precursors, competitive with the classical workflow. Direct plate making by inkjet has been described in the patent literature. Several conceptual approaches have been described. Directly hydrophobizing lithographic printing plate precursors, using a hydrophobic ink is a clearly preferred option.

Several types of hydrophobic inks have been described in the patent literature. U.S. Pat. No. 6,742,886 (KPG) discloses a method of preparing a printing plate by imagewise application onto a substrate of an inkjettable composition consisting essentially of an oleophilic polymer in an organic solvent. U.S. Pat. No. 5,511,477 (IDANIT TECH LTD) discloses a method for the production of printing plates by inkjet printing with a photopolymeric ink composition on a substrate and subjecting the resulting printed substrate to UV radiation thereby curing the ink composition.

Inkjet systems as the ones of the foregoing patents make use of organic solvent inks or UV-curing technology. However, aqueous based inkjet inks, requiring only a drying step after jetting thereby greatly reducing problems related to toxicology or to complexity of design of plate setters, have become the preferred choice for designing new inkjet plate setters.

An inkjet ink for direct plate making by inkjet has to meet several requirements at the same time. The chemistry in the ink should allow:
dot spread control on the surface of the printing plate precursor to guarantee the initial image quality,
a high run length under several press conditions,
a good resistance against press chemicals, and
a good visual contrast on the plate to allow visual inspection of the printing plate before mounting on the press and in future re-use of the printing plate.

Several aqueous based inks have been disclosed for preparing printing plates by inkjet.

EP 1157826 A (AGFA) discloses an aqueous inkjet fluid containing a oleophilizing compound having in its chemical structure a 1,2-dihydroxy aryl functional group, such as a catechol, a pyrogallol, and a salicylic acid.

EP 1157827 A (AGFA) discloses an aqueous inkjet fluid containing an oleophilizing compound having an 8-hydroxyquinoline moiety. Preferred compounds are 8-hydroxyquinolines, 7-hydroxybenzimidazoles, and 7-hydroxybenztriazoles.

EP 1157828 A (AGFA) discloses an inkjet fluid containing an oleophilizing compound containing a 1,3-dicarbonyl group in its chemical formula.

EP 1211063 A (AGFA) discloses an inkjet fluid containing an oleophilizing compound having in its chemical structure a boron containing group capable of reacting with said surface of said lithographic receiver.

EP 1219415 A (AGFA) discloses an inkjet fluid containing an oleophilizing compound having in its chemical structure a functional amidine group capable of reacting with the surface of a lithographic receiver. Preferably the amidine group is an imidazolidine group.

U.S. Pat. No. 6,532,871 (KPG) discloses a method of controlling the resolution of an image formed on a substrate, comprising:

(a) providing a substrate; and

(b) applying an image to the substrate by imagewise directly applying upon the substrate a fluid composition comprising at least one surfactant which is interfacially matched to the substrate, in which the dot size of the fluid composition on the substrate in the presence of the surfactant is less than the dot size of the fluid composition on the substrate in the absence of the surfactant, wherein an ink-absorbing layer is not applied to the substrate. In a preferred embodiment fluorinated surfactants on an anodized aluminium support are disclosed.

EP 1157825 A (AGFA) discloses an aqueous inkjet fluid containing an oleophilizing compound having in its chemical structure a phosphorous containing group capable of reacting with the surface of a lithographic receiver.

However further improvements are still required to obtain a method for making lithographic printing plates using inkjet technology having improved jetting performance and delivering printing plates which exhibit high printing quality, high resistance to fountain solutions and cleaning solutions, good visual contrast of the lithographic image and thereby avoiding the use of radiation curable materials or high concentrations of organic solvents.

### OBJECT OF THE INVENTION

It is an object of the present invention to provide a method for making lithographic printing plates using inkjet technology having improved jetting performance.

It is an object of the present invention to provide a method for making lithographic printing plates using inkjet technology delivering printing plates with high printing quality and high resistance to cleaning solutions.

It is an object of the present invention to provide a method for making lithographic printing plates using inkjet technology and good visual contrast between the printing areas and the non-printing areas of the lithographic printing plate.

These and other objects of the invention will become apparent from the description hereinafter.

### SUMMARY OF THE INVENTION

It was found that lithographic printing plates exhibiting high printing quality and high resistance to cleaning solutions were produced using simple aqueous fluids containing specific fluorosurfactants. Improvement of jetting performance was observed by increased latency time through the addition of an alkylene glycol and/or an alkylene glycol derivative to the aqueous fluid.

Objects of the present invention are realized with a method for making a lithographic printing plate comprising the steps of

a) providing an aqueous fluid containing at least 2 weight % of a fluorosurfactant based on the total weight of the aqueous fluid wherein the fluorosurfactant has a phosphorous containing group capable of reacting with the surface of a lithographic printing plate precursor; and
b) jetting the aqueous fluid on the surface of a lithographic printing plate precursor.

Further advantages and embodiments of the present invention will become apparent from the following description.

### DEFINITIONS

The term “lithographic printing plate” as used in disclosing the present invention, means a plate having a lithographic image on its surface.

The term “lithographic image” as used in disclosing the present invention means an image on a lithographic printing plate consisting of printing areas and non-printing areas.

The term “printing areas” as used in disclosing the present invention, means the areas of the image on a lithographic printing plate that are ink-receptive.

The term “non-printing areas” as used in disclosing the present invention, means the areas of the image on a lithographic printing plate that are ink-repellent.

The term “lithographic printing plate precursor” as used in disclosing the present invention means any plate with a surface capable of forming a lithographic image.

The term “dye”, as used in disclosing the present invention means a colorant having a solubility of 10 mg/L or more in the medium in which it is applied and under the ambient conditions pertaining.

The term “alkyl” means all variants possible for each number of carbon atoms in the alkyl group i.e. for three carbon atoms: n-propyl and isopropyl; for four carbon atoms: n-butyl, isobutyl and tertiary-butyl; for five carbon atoms: n-pentyl, 1,1-dimethyl-propyl, 2,2-dimethylpropyl and 2-methyl-butyl etc.

The term “acyl group” means —(C═O)-aryl; and —(C═O)-alkyl groups. The term “acyl group” means a —(C═O)-aryl group, a —(C═O)-alkyl group, a —(C═O)-heteroaryl group and —(C═O)-heterocyclic group. The term “aliphatic group” means saturated straight chain, branched chain and alicyclic hydrocarbon groups.

The term “unsaturated aliphatic group” means straight chain, branched chain and alicyclic hydrocarbon groups which contain at least one double or triple bond.

The term “aromatic group” as used in disclosing the present invention means an assemblage of cyclic conjugated carbon atoms, which are characterized by large resonance energies, e.g. benzene, naphthalene and anthracene.

The term “alicyclic hydrocarbon group” means an assemblage of cyclic carbon atoms, which do not form an aromatic group, e.g. cyclohexane.

The term “substituted” as used in disclosing this present invention means that one or more of the carbon atoms and/or hydrogen atoms of one or more of carbon atoms in an aliphatic group, an aromatic group or an alicyclic hydrocarbon group, are replaced by another atom, e.g. a halogen atom, an oxygen atom, a nitrogen atom, a silicon atom, a sulphur atom, a phosphorous atom, selenium atom or a tellurium atom. Such substituents include hydroxyl groups, ether groups, carboxylic acid groups, ester groups, amide groups and amine groups.

The term “heteroaromatic group” means an aromatic group wherein at least one of the cyclic conjugated carbon atoms is replaced by a non-carbon atom such as a nitrogen atom, a sulphur atom, a phosphorous atom, selenium atom and a tellurium atom.

The term “heterocyclic group” means an alicyclic hydrocarbon group wherein at least one of the cyclic carbon atoms is replaced by an oxygen atom, a nitrogen atom, a phosphorous atom, a silicon atom, a sulphur atom, a selenium atom or a tellurium atom.

### Methods for Making Lithographic Printing Plates

The method for making a lithographic printing plate according to the present invention comprises the steps of

a) providing an aqueous fluid containing at least 2 weight % of a fluorosurfactant based on the total weight of the aqueous fluid wherein the fluorosurfactant has a phosphorous containing group capable of reacting with the surface of a lithographic printing plate precursor; and
b) jetting the aqueous fluid on the surface of a lithographic printing plate precursor.

The jetting of the aqueous fluid is performed by an inkjet printer. In ink jet printing tiny drops of fluid are projected directly onto an ink receptor surface without physical contact between the printing device and the receptor. The printing device stores the printing data electronically and controls a mechanism for ejecting the drops image-wise. Printing may be accomplished by moving the print head across the lithographic printing plate precursor or vice versa. The inkjet printing may also be a “single pass printing process”. This is a printing mode, which can be performed by using page wide inkjet printing heads or multiple staggered inkjet printing heads that cover the entire width of the ink-receiver surface. In a single pass printing process the inkjet printing heads usually remain stationary and the lithographic printing plate precursor surface is transported under the inkjet printing heads. An example of such a single pass inkjet printer is “The Dot Factory” manufactured by AGFA.

The jetting of the aqueous fluid droplets can be performed in several different ways. In a first type of process a continuous droplet stream is created by applying a pressure wave pattern. This process is known as continuous ink jet printing. In a first embodiment the droplet stream is divided into droplets that are electrostatically charged, deflected and recollected, and into droplets that remain uncharged, continue their way undeflected, and form the image. Alternatively, the charged deflected stream forms the image and the uncharged undeflected jet is recollected. In this variant of continuous ink jet printing several jets are deflected to a different degree and thus record the image (multideflection system).

According to a second process the aqueous fluid droplets can be created “on demand” (“DOD” or “drop on demand” method) whereby the printing device ejects the droplets only when they are used in imaging on a receiver thereby avoiding the complexity of drop charging, deflection hardware, and aqueous fluid recollection. In drop-on-demand the aqueous fluid droplet can be formed by means of a pressure wave created by a mechanical motion of a piezoelectric transducer (so-called “piezo method”), or by means of discrete thermal pushes (so-called “bubble jet” method, or “thermal jet” method).

In a preferred embodiment of the method for making a lithographic printing plate according to the present invention the inkjet printer is mounted on the printing press. For coloured printing matter, the printing press usually comprises four print cylinders. A plate is mounted on each print cylinder for each of the four printing inks (CMYK); in this case each print cylinder may have its own inkjet printer.

In a preferred embodiment of the method for direct plate making according to present invention a gum solution is jetted on the lithographic non-image, i.e. the non-printing areas of the lithographic image. In this case the inkjet printer has at least one print head ejecting small droplets of gum solution in a controlled manner through nozzles onto the surface of a lithographic printing plate, which is moving relative to the printing head(s). The jetted gum solution forms a hydrophilic protective layer on the non-printing areas and optionally the printing areas of the lithographic printing plate. Preferably the gum solution for the non-printing areas is jetted in the same printing process with the aqueous fluid used to form the printing areas of a lithographic image on a lithographic printing plate. According to another embodiment, the gum solution for the non-printing areas and the aqueous fluid used to form the printing areas of lithographic image on the lithographic printing plate are jetted by the same inkjet print head.

### Aqueous Fluids

The aqueous fluid contains at least 2 weight %, more preferably at least 4 weight % of a fluorosurfactant based on the total weight of the aqueous fluid. The fluorosurfactant has a phosphorous containing group capable of reacting with the surface of a lithographic printing plate precursor.

The aqueous fluid for use in a method according to the present invention may further contain a mixture of fluorosurfactants.

The aqueous fluid for use in a method according to the present invention may further contain a second surfactant without a phosphorous containing group capable of reacting with the surface of a lithographic printing plate precursor. The surfactant may be selected from the list consisting of fatty acid salts, ester salts of a higher alcohol, alkylbenzene sulphonate salts, sulphosuccinate ester salts and phosphate ester salts of a higher alcohol (for example, sodium dodecylbenzenesulphonate and sodium dioctylsulphosuccinate), ethylene oxide adducts of a higher alcohol, ethylene oxide adducts of an alkylphenol, ethylene oxide adducts of a polyhydric alcohol fatty acid ester, and acetylene glycol and ethylene oxide adducts thereof (for example, polyoxyethylene nonylphenyl ether, and SURFYNOL™ 104, 104H, 440, 465 and TG available from AIR PRODUCTS & CHEMICALS INC.), but is preferably a fluorosurfactant.

In a preferred embodiment the aqueous fluid for use in a method according to the present invention contains only fluorosurfactants with a phosphorous containing group capable of reacting with the surface of a lithographic printing plate precursor.

The aqueous fluid for use in a method according to the present invention may further contain an oleophilizing compound

The aqueous fluid for use in a method according to the present invention may further contain a colorant.

The aqueous fluid for use in a method according to the present invention may further contain one or more organic solvents.

The aqueous fluid for use in a method according to the present invention may further contain a pH-control agent.

The aqueous fluid for use in a method according to the present invention may further contain a polymer.

The aqueous fluid for use in a method according to the present invention may further contain typical inkjet ink additives such as biocides, viscosity regulators, humectants, etc.

### Fluorosurfactants

The fluorosurfactant has a phosphorous containing group capable of reacting with the surface of a lithographic printing plate precursor. The phosphorous containing group capable of reacting with the surface of a lithographic receiver is preferably selected from the group consisting of —O—PO₃H₂, —O—PO₃HR, —O—PO₃(NH₄)₂, —O—PO₃H(NH₄), —PO₃H₂ or —PO₃HR, —PO₃(NH₄)₂ or —PO₃H(NH₄) with R representing methyl or ethyl.

The fluorosurfactant may be represented by Formula (I):

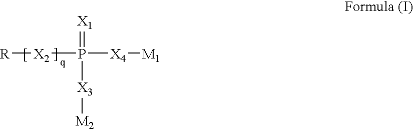

wherein
X₁, X₂, X₃ and X₄ are independently selected from oxygen or sulfur;
q represents 0 or 1;
M₁ is a proton or a counterion to compensate the negative charge of X₄;
M₂ is a proton or a counterion to compensate the negative charge of X₃ or represents a substituted or unsubstituted, saturated or unsaturated aliphatic chain, a substituted or unsubstituted aryl or hetero-aryl group; and
R represents an aliphatic group containing fluorine atoms. The counterion M₁ and M₂ are preferably independently selected from the group consisting of NH₄⁺, K⁺, Na⁺, Li⁺ and K⁺. In a preferred embodiment X₁, X₂, X₃ and X₄ represent oxygen. In another preferred embodiment the aliphatic group R contains at least 6 carbon atoms. The aliphatic group R is preferably a straight chain aliphatic group. In a preferred embodiment the straight chain aliphatic group comprises a group represented by —(CF₂—CF₂)ₙCF₃ wherein n is an integer between 3 and 20. The aliphatic group may be an unsaturated aliphatic group or a substituted aliphatic group. The aliphatic group may also be a substituted unsaturated aliphatic group.

In another preferred embodiment the fluorosurfactant is represented by Formula (II):

(F(CF₂CF₂)ₐCH₂CH₂O)ₓP(O)(ONH₄)_{y} Formula (II)

wherein
x and y represent 1 or 2 with x+y=3; and
a represents an integer between 1 and 8.

In another preferred embodiment the fluorosurfactant is less than 1.0 weight %, more preferably less than 0.5 weight % soluble and most preferably insoluble in isopropanol. It was found that aqueous fluids containing such fluorosurfactants, such as for example Zonyl™ FSE from Du Pont, exhibited a very high resistance to cleaning solutions and excellent printing run lengths.

The aqueous fluid for use in a method according to the present invention contains at least 2 weight % of a fluorosurfactant, more preferably at least 3 weight % of a fluorosurfactant and most preferably at least 4 weight % of a fluorosurfactant based on the total weight of the aqueous fluid. The aqueous fluid for use in a method according to the present invention contains preferably no more than 10 weight % of a fluorosurfactant, more preferably no more than 8 weight % of a fluorosurfactant based on the total weight of the aqueous fluid.

### Oleophilizing Compounds

An oleophilizing compound or hydrophobizing compound may be added to the aqueous fluid for use in a method according to the present invention to form in combination with the fluorosurfactant the printing areas of the lithographic image.

The hydrophobizing compound is preferably selected from the group consisting of a phosphate or salt thereof, a phosphonate or salt thereof, a boronic acid derivative, a 1,3-dicarbonyl compound, an imidazoline derivative and a catechol or pyrogallol derivative. Phosphates and phosphonates are particularly preferred.

Suitable hydrophobizing compounds may be selected from those disclosed in EP 1157825A(AGFA), EP 1157826A(AGFA), EP 1157827 A (AGFA), EP 1157828 A (AGFA), EP 1211063 A (AGFA), EP 1219415 AAGFA), U.S. Pat. No. 6,532,871 (KPG) and EP 0882584 A (KODAK).

### Colorants

The aqueous fluid for use in a method according to the present invention may further contain at least one colorant to give a visual contrast between the printing areas and the non-printing areas of the lithographic plate. The colorant is preferably a dye, more preferably an anionic dye.

Any dye absorbing light between 400 and 700 nm may be used. The dye may have a wavelength of maximum absorption λₘₐₓ located outside the wavelength region of 400 and 700 nm, for example at 320 nm or at 830 nm, as long as a sufficient portion of light is absorbed between 400 and 700 nm, such that it allows the human eye to differentiate printing areas from non-printing areas on the lithographic printing plate.

Suitable dyes may be selected from the group consisting of an azo dye with a molar extinction coefficient larger than 10³/mol⁻¹ cm⁻¹, an anthraquinone dye, a (poly)methine dye, an azomethine dye, a disazo dye, a carbonium dye, a styryl dye, a stilbene dye, a phthalocyanine dye, a coumarin dye, an aryl-carbonium dye, a nitro dye, a naphtholactam dye, a dioxazine dye, a flavin dye and a formazan dye.

In a preferred embodiment the dye comprises at least one phosphorous containing group capable of reacting with the surface of a lithographic printing plate precursor.

In a preferred embodiment the phosphorous containing group capable of reacting with the surface of a lithographic receiver is represented by Formula (III):

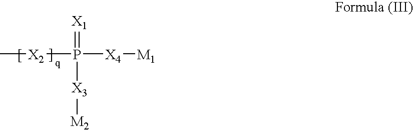

wherein
X₁, X₂, X₃ and X₄ are independently selected from oxygen or sulfur;
q represents 0 or 1;
M₁ is a proton or a counterion to compensate the negative charge of X₄
M₂ is a proton or a counterion to compensate the negative charge of X₃ or represents a substituted or unsubstituted, saturated or unsaturated aliphatic chain, a substituted or unsubstituted aryl or hetero-aryl group.

Preferably the phosphorous containing group capable of reacting with the surface of a lithographic receiver represented by Formula (I) is selected from the group consisting of —O—PO₃H₂, —O—PO₃HR, —PO₃H₂ or —PO₃HR with R representing methyl or ethyl.

### Organic Solvents

The aqueous fluid for use in a method according to the present invention may further contain at least one organic solvent. The organic solvent is preferably added in an amount of 1 to 40 wt %, more preferably 2 to 20 wt %, and most preferably 5 to 10 wt % each based on the total weight of the aqueous fluid.

Suitable organic solvents include alcohols, aromatic hydrocarbons, ketones, esters, aliphatic hydrocarbons, higher fatty acids, carbitols, cellosolves, higher fatty acid esters. Suitable alcohols include, methanol, ethanol, propanol and 1-butanol, 1-pentanol, 2-butanol, t.-butanol. Suitable aromatic hydrocarbons include toluene, and xylene. Suitable ketones include methyl ethyl ketone, methyl isobutyl ketone, 2,4-pentanedione and hexafluoroacetone. Also glycol, glycolethers, N-methylpyrrolidone, N,N-dimethylacetamid, N,N-dimethylformamid may be used.

An organic solvent can also be present in the aqueous fluid according to the present invention as a humectant to prevent the clogging of the nozzle, due to its ability to slow down the evaporation rate of fluid.

In a preferred embodiment the aqueous fluid contains an alkylene glycol and/or an alkylene glycol derivative. Suitable alkylene glycol derivatives include alkylene glycol ethers, alkylene glycol esters and mixed ether/esters of alkylene glycols.

Suitable humectants include triacetin, N-methyl-2-pyrrolidone, glycerol, urea, thiourea, ethylene urea, alkyl urea, alkyl thiourea, dialkyl urea and dialkyl thiourea, diols, including ethanediols, propanediols, propanetriols, butanediols, pentanediols, and hexanediols; glycols, including propylene glycol, polypropylene glycol, ethylene glycol, polyethylene glycol, diethylene glycol, tetraethylene glycol, and mixtures and derivatives thereof. Preferred humectants are triethylene glycol mono butylether, glycerol and 1,2-hexanediol. The humectant is preferably added to the aqueous fluid in an amount of 0.1 to 40 wt %, more preferably 2 to 35 wt %, and most preferably approximately 10 to 30 wt % each based on the total weight of the aqueous fluid. The total amount of organic solvent and humectant in the aqueous fluid is preferably in the range of 5 to 40 wt %, more preferably 15 to 30 wt % each based on the total weight of the aqueous fluid.

### pH Control Agents

A pH control agent may also be present in the aqueous fluid. The aqueous fluid has preferably a pH from 3 to 10. The pH of the aqueous fluid is usually adjusted with an acid or a base such as a mineral acid, an organic acid, an organic base or an inorganic salt. For dissolving the dye better, higher amounts of a pH control agent may be used.

Examples of the mineral acids include nitric acid, sulfuric acid, phosphoric acid and metaphosphoric acid. Especially organic acids are used as pH control agents and as desensitizing agents. Examples of the organic acids include carboxylic acids, sulfonic acids, phosphonic acids or salts thereof, e.g. succinates, phosphates, phosphonates, sulfates and sulfonates.

Specific examples of the organic acid include citric acid, acetic acid, oxalic acid, malonic acid, p-toluenesulfonic acid, tartaric acid, malic acid, lactic acid, levulinic acid, phytic acid and organic phosphonic acid.

Examples of inorganic bases are hydroxides of alkali or rare earth metals, ammonium hydroxide, hydroxylamine. Suitable examples of organic bases are amines as e.g. triethanolamine, triethylamine, tributylamine, dimethylethanolamine, diisopropylamin and heterocyclic compounds such as pyrazine.

Examples of the inorganic salt include magnesium nitrate, monobasic sodium phosphate, dibasic sodium phosphate, nickel sulfate, sodium hexametaphosphate and sodium tripolyphosphate. Other inorganic salts can be used as corrosion inhibiting agents, e.g. magnesium sulfate or zinc nitrate.

The mineral acid, organic acid, organic base or inorganic salt may be used singly or in combination with one or more thereof.

### Polymer

The aqueous fluid according to the present invention may further contain a polymer.

In a preferred embodiment the polymer is an acidic polymer. Suitable polymers include poly(acrylic acid), poly(methacrylic acid), poly(maleic acid), poly(maleic anhydride), poly(fumaric acid), poly(fumaric anhydride), poly(styrene-co-acrylic acid), poly(styrene-co-maleic acid), poly(styrene-co-fumaric acid), polymers of ethylenically unsaturated sulfonic acid, polymers of sulfonated styrene, and mixtures or derivatives thereof.

In a preferred embodiment the polymer has a phosphorous containing group capable of reacting with the surface of a lithographic printing plate precursor.

### Lithographic Printing Plate Precursors

The lithographic printing plate precursor may be a sheet-like material such as a plate or it may be a cylindrical element such as a sleeve which can be slid around a print cylinder of a printing press.

A particularly preferred printing plate precursor is an electrochemically grained and anodized aluminum support. Graining and anodizing of aluminum supports is well known. The acid used for graining can be e.g. nitric acid or sulfuric acid. The acid used for graining preferably comprises hydrogen chloride. Also mixtures of e.g. hydrogen chloride and acetic acid can be used. The relation between electrochemical graining and anodizing parameters such as electrode voltage, nature and concentration of the acid electrolyte or power consumption on the one hand and the obtained lithographic quality in terms of Ra and anodic weight (g/m² of Al₂O₃ formed on the aluminum surface) on the other hand is well known. More details about the relation between various production parameters and Ra or anodic weight can be found in e.g. the article “Management of Change in the Aluminium Printing Industry” by F. R. Mayers, published in the ATB Metallurgie Journal, volume 42 nr. 1-2 (2002) pag. 69.

With regard to the anodizing treatment, methods that have been conventionally used in this field can be used. Specifically, when direct or alternative current is fed to the aluminum plates in aqueous solution or non aqueous solution, alone or in combination, of sulfuric acid, phosphoric acid, chromic acid, oxalic acid, sulfamic acid, benzenesulfonic acid and the like, an anodized layer can be formed on the surface of the aluminum plate. Since conditions for anodizing treatment change variously depending on the electrolyte being used, those are not decided unconditionally, but it is generally appropriate that the concentration of electrolyte is 1 to 80 wt %, temperature of solution is 8 to 70° C., preferably 25 to 55° C., current density is 0.5 to 70 A/dm², preferably 15 to 60 A/dm², voltage is 1 to 200 V, and time for electrolysis is 1 to 100 seconds, preferably 5 to 60 seconds.

The anodized aluminum support may be subject to a so-called post-anodic treatment to improve the hydrophilic properties of its surface. For example, the aluminum support may be silicated by treating its surface with a sodium silicate solution at elevated temperature, e.g. 95° C. Alternatively, a phosphate treatment may be applied which involves treating the aluminum oxide surface with a phosphate solution that may further contain an inorganic fluoride. Further, the aluminum oxide surface may be rinsed with a citric acid or citrate solution. This treatment may be carried out at room temperature or may be carried out at a slightly elevated temperature of about 30 to 50° C. A further interesting treatment involves rinsing the aluminum oxide surface with a bicarbonate solution. Still further, the aluminum oxide surface may be treated with polyvinylphosphonic acid, polyvinylmethylphosphonic acid, phosphoric acid esters of polyvinyl alcohol, polyvinylsulfonic acid, polyvinylbenzenesulfonic acid, sulfuric acid esters of polyvinyl alcohol, and acetals of polyvinyl alcohols formed by reaction with a sulfonated aliphatic aldehyde.

Another useful post-anodic treatment may be carried out with a solution of polyacrylic acid or a polymer comprising at least 30 mol % of acrylic acid monomeric units, e.g. GLASCOL E15, a polyacrylic acid, commercially available from ALLIED COLLOIDS.

According to another embodiment, the support can also be a flexible support, which may be provided with a hydrophilic layer, hereinafter called ‘base layer’. The flexible support is e.g. paper, plastic film or aluminum. Preferred examples of plastic film are polyethylene terephthalate film, polyethylene naphthalate film, cellulose acetate film, polystyrene film, polycarbonate film, etc. The plastic film support may be opaque or transparent.

The base layer is preferably a cross-linked hydrophilic layer obtained from a hydrophilic binder cross-linked with a hardening agent such as formaldehyde, glyoxal, polyisocyanate or a hydrolyzed tetra-alkylorthosilicate. The latter is particularly preferred. The thickness of the hydrophilic base layer may vary in the range of 0.2 to 25 μm and is preferably 1 to 10 μm.

### EXAMPLES

The present invention will now be illustrated by the following examples without however being limited thereto.

### Materials

All materials used in the following examples were readily available from Aldrich Chemical Co. (Belgium) unless otherwise specified. The “water” used in the examples was demineralized water. The following materials were used:

Zonyl™ FSA a water-soluble, anionic fluorosurfactant with a lithium carboxylate end group from DuPont.

Zonyl™ FS-62 is a water-soluble, anionic fluorosurfactant with a sulfonate end group from DuPont.

Zonyl™ FS-300 is a water-soluble, non-ionic fluorosurfactant from DuPont.

Zonyl™ FSO-100 is an ethoxylated non-ionic fluorosurfactant from DuPont.

Zonyl™ FSN is a water-soluble, ethoxylated non-ionic fluorosurfactant from DuPont.

Zonyl™ FSP is a water-soluble, anionic phosphate fluorosurfactant from DuPuont.

Zonyl™ FSE is a water-soluble, anionic phosphate fluorosurfactant from DuPont.

Surfynol™ SE-F is a nonionic self-emulsifiable surfactant from Air Products.

Duasyn™ Dir. Turq. Blue FRL-SF is C.I. Direct Blue 199 from Clariant Benelux NV.

Propylene glycol from Caldic Belgium NV.

Diethylene glycol from BASF Belgium NV.

Isopropanol from Caldic Belgium NV.

Substrates:

SAA is a grained and anodized aluminium substrate. Graining was carried out in a 2 cell grainer using HCl (9.5 and 9.7 g/L respectively)/CH₃COOH (17.6 and 18.5 g/L respectively) as an acid mixture, at a temperature of 26.5° and 25.3° C. and voltages of 21 and 22 V. Anodisation was carried out in 2 cells containing sulfuric acid (129 g/L and 119 g/L respectively) at 45° C. and 46.1° C. and voltages of 25.9 V and 25 V resulting in an anodic weight of 6.6 g/m². No post anodic treatment was given. SAA+PAT is a grained and anodised substrate as described above with a post anodic treatment using NaHCO₃.

MAA is a grained and anodized aluminium substrate, but differs from the method for preparing SAA substrate in that the anodisation was carried out in a mixture of H₃PO₄ and H₂SO₄ (respectively 332 g/L and 52.9 g/L). The temperature of the anodisation liquid was 44° C. and the resulting anodic weight was 2.43 g/m². No post anodic treatment was given.

Cleaning Solutions:

Fortakleen™ RC95 from AGFA.

Normakleen™ RC910 from AGFA.

Fountain Solution:

FS101™ fountain solution from AGFA.

Pantheon 2step HDi from Varn Products Company Ltd (England).

Alcohol 595 from Varn Products Company Ltd (England)

Printing Inks:

Skinnex™ X800 black ink from BASF-Drucksysteme Gmbh.

Superior™ Magenta ink from Superior Printing Ink Company (New York, USA)

Measurement Methods

### 1. Optical Density and % Dot

The optical density and % dot were measured using a Gretag D19C densitometer with Wratten 47B filter (black values). The values of the optical density and % dot for the prints were measured with substraction of the optical density of the unprinted paper.

### 2. Printing Quality

The printing quality was investigated by mounting the printing plate on a Heidelberg sheet fed GT046 offset press using a mixture of 3% FS101™ and 10% isopropanol as a fountain solution. Skinnex X800 black ink was used for printing on Rey Today Office Paper 80 g/m² delivered by GPG Papier NV. The optical density of the unprinted paper was 0.09.

A measure for the print quality is the optical density in the image area of the 1000^{th} printed sheet. In order to have a printed image, there needs to be a clear difference in optical density between the unprinted area and the printed area on the printed sheet.

### 3. Resistance to Cleaning Solution

First a print run was performed on a Heidelberg sheet fed GT046 offset press on Rey Today Office Paper 80 g/m² delivered by GPG Papier NV.

Then the used printing plate was cleaned by applying cleaning solution by means of wiping with a cloth soaked with cleaning solution. Fortakleen RC95 or Normakleen RC910 was used as cleaning solution.

A second print run of 250 prints was then performed on the cleaned printing plate using the same print conditions as in the first print run.

The chemical resistance was evaluated by comparing the % dot of the 1,000^{th} print sheet of the first print run with the 250^{th} print sheet of the second print run. The evaluation was performed on three different substrates (MAA, SAA and SAA+PAT) as indicated by the examples.

For printing on paper, two print conditions were used:
Condition A using a mixture of 3% FS101 fountain solution and 10% isopropanol as fountain solution and Skinnex X800 black ink as printing ink; and
Condition B using Varn 2step Pantheon HDi (3%) and Varn Alcohol substitute 595 (4%) as fountain solutions and Superior Magenta ink as printing ink.

A good resistance for the cleaning solution means that the % loss of % dot after cleaning should be lower than 25%. The % loss of % dot is defined according to following formula:

$$\% loss of \% dot = 100 \% - \frac{\% dot on {250}^{th} print sheet of the second print run}{\% dot on {100}^{th} print sheet of the first print run}$$

### 4. Latency Time

For the jetting performance, the latency time was tested by jetting a print patch of the aqueous fluid containing a fluorosurfactant by a custom built ink-jet printer equipped with an UPH print head from AGFA at 360 dpi resolution and with 1 dpd (drops per dot) using the optimal conditions for firing the fluid 3 pL drops (optimized voltage and sampleclock values), such that all nozzles are firing. Then the print head was kept at rest during increasing time intervals starting from 1 minute and increasing by 2 minutes until a number of nozzles did not fire the aqueous fluid. The latency time is the longest time interval wherein the print head is at rest and whereafter all nozzles still fire the aqueous fluid so that a complete print patch (without lines due to failing nozzles) is received.

An evaluation was made in accordance with the criterion described below in Table 1.

TABLE 1

| Latency time | Criterion |
|---|---|
| 15 min or less | − |
| 15 min | 0 |
| 15-30 min | + |
| More than 30 min | ++ |

### Example 1

This example illustrates the ink acceptance of printing plates obtained by jetting aqueous fluids containing a fluorosurfactant in accordance with the invention compared to aqueous fluids containing comparison fluorosurfactants.

### Preparation of Aqueous Fluids

All aqueous fluids were prepared in the same manner to obtain a composition as described in Table 2 for the comparative aqueous fluids COMP-1 to COMP-4 and the inventive aqueous fluids INV-1 to INV-2. The amounts of the components are given in weight percentages based on the total weight of the aqueous fluids.

TABLE 2

| | weight % of component: | | | | | |
|---|---|---|---|---|---|---|
| | COMP- | COMP- | COMP- | COMP- | INV- | INV- |
| | 1 | 2 | 3 | 4 | 1 | 2 |
| Zonyl ™ FS-300 | 2 | — | — | — | — | — |
| Zonyl ™ FSN | — | 2 | — | — | — | — |
| Zonyl ™ FSO-100 | — | — | 2 | — | — | — |
| Zonyl ™ FS-62 | — | — | — | 2 | — | — |
| Zonyl ™ FSE | — | — | — | — | 2 | — |
| Zonyl ™ FSP | — | — | — | — | — | 2 |
| DYE-1 | 1 | 1 | 1 | 1 | 1 | 1 |
| Propylene glycol | 18 | 18 | 18 | 18 | 18 | 18 |
| Water | 79 | 79 | 79 | 79 | 79 | 79 |

First the liquid carrier composition of water and proylene glycol was prepared under stirring at room temperature. Then the colorant DYE-1 was introduced into this carrier under stirring. Finally the fluorosurfactant was added.

### Evaluation and Results

The comparative aqueous fluids COMP-1 to COMP-4 and the inventive aqueous fluids INV-1 to INV-2 were jetted as 3 pL drops by a custom built ink-jet printer equipped with an UPH print head from AGFA at 360 dpi resolution and with 15 dpd (drops per dot) on a MAA substrate such that a lithographic printing plate was obtained having printing areas and non-printing areas. After drying the printing quality of the obtained lithographic printing plates was evaluated by measuring the optical density on the printed sheet number 1,000. The results are shown in Table 3.

TABLE 3

| Aqueous fluid | Optical density |
|---|---|
| COMP-1 | 0.00 |
| COMP-2 | 0.00 |
| COMP-3 | 0.00 |
| COMP-4 | 0.09 |
| INV-1 | 1.53 |
| INV-2 | 1.41 |

The results of Table 3 show that only the inventive aqueous fluids INV-1 to INV-2 containing an anionic phosphate fluorosurfactant delivered lithographic printing plates exhibiting a good ink-uptake.

The lithographic printing plates prepared using the comparative aqueous fluids COMP-1 to COMP-4 exhibited no or hardly any ink acceptance and hence could not render a good image on the printed sheet.

### Example 2

This example illustrates that high concentrations of fluorosurfactant in the aqueous fluids are required for obtaining lithographic printing plates that exhibit a high chemical resistance to cleaning solutions. It is also shown how alkylene glycols improve the jetting characteristics without deterioration of printing quality or chemical resistance to cleaning solutions.

### Preparation of Aqueous Fluids

All aqueous fluids were prepared in the same manner to obtain a composition as described in Table 4 for the comparative aqueous fluids COMP-5 to COMP-7 and the inventive aqueous fluids INV-3 to INV-5. The amounts of the components are given in weight percentages based on the total weight of the aqueous fluids.

TABLE 4

| | weight % of component: | | | | | |
|---|---|---|---|---|---|---|
| | COMP- | COMP- | COMP- | INV- | INV- | INV- |
| | 5 | 6 | 7 | 3 | 4 | 5 |
| Zonyl ™ FSP | 0.50 | 0.50 | — | 2.00 | 2.00 | — |
| Zonyl ™ FSA | — | — | 2.00 | — | — | — |
| Zonyl ™ FSE | — | — | — | — | — | 2.00 |
| Surfynol ™ SE-F | 0.05 | — | — | — | — | — |
| DYE-1 | 1.00 | 1.00 | 1.00 | 1.00 | 1.00 | 1.00 |
| Propylene glycol | — | — | 18.00 | 18.00 | 21.00 | 21.00 |
| Diethylene glycol | — | — | — | — | 7.00 | 7.00 |
| Water | 98.45 | 98.50 | 79.00 | 79.00 | 69.00 | 69.00 |

First the liquid carrier composition was prepared by adding if present under stirring at room temperature the organic solvents, i.e. propylene glycol and diethylene glycol, to demineralised water and stirring was continued until a homogeneous solution was obtained. Then the colorant DYE-1 was introduced into this carrier under stirring. Finally the non-ionic surfactant Surfynol™ SE-F, if present, and the fluorosurfactant was added.

### Evaluation and Results

The comparative aqueous fluids COMP-5 to COMP-7 and the inventive aqueous fluids INV-3 to INV-5 were jetted by a custom built ink-jet printer equipped with an UPH print head from AGFA at 360 dpi resolution using a print mode with 1 to 7 dpd (droplets per dot) on a MAA substrate and a SSA substrate such that a lithographic printing plate was obtained having printing areas and non-printing areas. After drying the printing quality of the obtained lithographic printing plates was evaluated by measuring the optical density on the printed sheet number 1000. The results are shown in Table 5.

### Table 5

Optical density for 7 dpd

| | Printing plate with | Printing plate with |
|---|---|---|
| Aqueous fluid | SAA substrate | MAA substrate |
| COMP-5 | 0.53 | 1.03 |
| COMP-6 | 0.47 | 1.14 |
| COMP-7 | 0.00 | 0.88 |
| INV-3 | 1.02 | 1.39 |
| INV-4 | 0.38 | 0.54 |
| INV-5 | 0.40 | 0.97 |

The chemical resistance to cleaning solutions was then evaluated for lithographic printing plates. The results for the most aggressive cleaning solution, i.e. Fortakleen RC95, on a lithographic printing plate having a MAA substrate are shown in Table 6 for dots jetted at 3 dpd.

TABLE 6

| | % dot of 1,000^{th} | % dot of 250^{th} | |
|---|---|---|---|
| Aqueous | printed sheet of | printed sheet of | |
| fluid | the 1^{st} print run | the 2^{nd} print run | % loss of % dot |
| COMP-5 | 42 | 19 | 55% |
| COMP-6 | 11 | 6 | 45% |
| COMP-7 | 23 | 8 | 65% |
| INV-3 | 41 | 39 | 5% |
| INV-4 | 47 | 43 | 8% |
| INV-5 | 35 | 35 | 0% |

The comparative aqueous fluids COMP-5 to COMP-7 and the inventive aqueous fluids INV-3 to INV-5 were also evaluated at 1 dpd for their latency time. The results for the jetting performance are shown in Table 7.

TABLE 7

| Aqueous fluid | Latency |
|---|---|
| COMP-5 | − |
| COMP-6 | − |
| COMP-7 | + |
| INV-3 | + |
| INV-4 | ++ |
| INV-5 | ++ |

Table 5, Table 6 and Table 7 show that only the inventive aqueous fluids INV-3 to INV-5 delivered chemically resistant lithographic plates with high printing quality. It was also observed that the addition of propylene glycol and diethylene glycol to the inventive aqueous fluids INV-4 and INV-5 not only exhibited excellent latency times but also an improved drop placement accuracy.

### Example 3

This example illustrates the effect of the concentration in the aqueous fluid of the fluorosurfactant on the resistance to cleaning solutions.

### Preparation of Aqueous Fluids

The inventive aqueous fluids INV-6 and INV-7 were prepared in the same manner to obtain a composition according to Table 8. The amounts of the components are given in weight percentages based on the total weight of the aqueous fluid composition.

TABLE 8

| weight % of | | |
|---|---|---|
| component: | INV-6 | INV-7 |
| Zonyl ™ FSE | 2 | 4 |
| DYE-1 | 1 | 1 |
| Propylene glycol | 21 | 21 |
| Diethylene glycol | 7 | 7 |
| Water | 69 | 67 |

### Evaluation and Results

The inventive aqueous fluids INV-6 and INV-7 were jetted as 3 pL drops by a custom built ink-jet printer equipped with an UPH print head from AGFA at 3 dpd at 360 dpi resolution on 3 different substrates, i.e. MAA, SAA and SAA+PAT substrate, such that a lithographic printing plate was obtained having printing areas and non-printing areas. After drying the printing quality of the obtained lithographic printing plates was evaluated by measuring the optical density on the printed sheets after a 1,000 printed copies and after every 10,000^{Th} printed copy. The printing quality was found to be constant for both inventive aqueous fluids INV-6 and INV-7 at a printing run-length of 50,000 prints.

Then the resistance to the Normakleen RC910 cleaning solution was tested. After the cleaning step, a second print run was performed and the 250^{th} printed sheet was compared to the 50,000^{th} printed sheet of the first print run. The evaluation of the resistance to the cleaning solution was tested for two printing conditions using different fountain solutions and printing inks. The results are shown in Table 9.

TABLE 9

| | | % loss of % dot | |
|---|---|---|---|
| Aqueous fluid | Substrate | Print condition A | Print condition B |
| Liquid INV-6 | MAA | 22% | 5% |
| | SAA | 78% | 38% |
| | SAA + PAT | 18% | 0% |
| Liquid INV-7 | MAA | 14% | 2% |
| | SAA | 13% | 0% |
| | SAA + PAT | 5% | 0% |

From Table 9 is can be seen that the higher concentration of the fluorosurfactant in the aqueous fluid exhibits a higher chemical resistance to cleaning solutions for different printing conditions.

1-16. (canceled)

17: A method for making a lithographic printing plate comprising the steps of:
a) providing an aqueous fluid containing at least 2 weight % of a fluorosurfactant based on the total weight of the aqueous fluid, wherein the fluorosurfactant has a phosphorous containing group capable of reacting with the surface of a lithographic printing plate precursor; and
b) jetting the aqueous fluid onto the surface of the lithographic printing plate precursor.

18: A method according to claim 17, wherein the fluorosurfactant is represented by Formula (I): 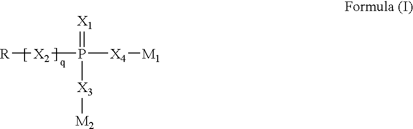
wherein
X₁, X₂, X₃, and X₄ are independently selected from oxygen or sulfur;
q represents 0 or 1;
M₁ is a proton or a counterion to compensate for the negative charge of X₄;
M₂ is a proton or a counterion to compensate for the negative charge of X₃ or represents a substituted or unsubstituted, saturated or unsaturated aliphatic chain, a substituted or unsubstituted aryl or hetero-aryl group; and
R represents an aliphatic group containing fluorine atoms.

19: A method according to claim 18, wherein the counterions M₁ and M₂ are
independently selected from the group consisting of NH₄⁺, K⁺, Na⁺, Li⁺, and K⁺.

20: A method according to claim 18, wherein X₁, X₂, X₃, and X₄ represent oxygen.

21: A method according to claim 18, wherein the aliphatic group R contains at least 6 carbon atoms.

22: A method according to claim 20, wherein the aliphatic group R contains at least 6 carbon atoms.

23: A method according to claim 21, wherein the aliphatic group R is a straight chain aliphatic group.

24: A method according to claim 22, wherein the aliphatic group R is a straight chain aliphatic group.

25: A method according to claim 23, wherein the straight chain aliphatic group includes a group represented by —(CF₂—CF₂)ₙCF₃ wherein n is an integer between 3 and 20.

26: A method according to claim 24, wherein the straight chain aliphatic group includes a group represented by —(CF₂—CF₂)ₙCF₃ wherein n is an integer between 3 and 20.

27: A method according to claim 17, wherein the fluorosurfactant is represented by
Formula (II):
(F(CF₂CF₂)ₐCH₂CH₂O)ₓP(O)(ONH₄)_{y} Formula (II)
wherein
x and y represent 1 or 2 and x+y=3; and
a represents an integer between 1 and 8.

28: A method according to claim 17, wherein the phosphorous containing group capable of reacting with the surface of the lithographic receiver is selected from the group consisting of —O—PO₃H₂, —O—PO₃HR, —O—PO₃(NH₄)₂, —O—PO₃H(NH₄), —PO₃H₂ or —PO₃HR, —PO₃(NH₄)₂ or —PO₃H(NH₄) with R representing methyl or ethyl.

29: A method according to claim 17, wherein the fluorosurfactant is less than 0.5 weight % soluble in isopropanol.

30: A method according to claim 17, wherein the aqueous fluid contains one or more humectants.

31: A method according to claim 30, wherein the humectant is an alkylene glycol and/or an alkylene glycol ether.

32: A method according to claim 17, wherein the aqueous fluid contains a colorant.

33: A method according to claim 32, wherein the colorant is an anionic dye.

34: A method according to claim 17, wherein the lithographic printing plate precursor is mounted on a printing press before jetting the aqueous fluid onto the surface of the lithographic printing plate precursor.

35: A method according to claim 17, further comprising jetting a gum solution onto the non-printing areas of the lithographic printing plate.
